(19) United States
(12) Patent Application Publication
(10) Pub. No.: US 2009/0228488 A1
(43) Pub. Date: Sep. 10, 2009

(54) DATA SAFETY APPLIANCE AND METHOD

(76) Inventors: Kim Brand, Greenfield, IN (US); Thomas M. Lapp, Indianapolis, IN (US)

Correspondence Address: OVERHAUSER LAW OFFICES, LLC;DOCKETING DEPARTMENT, 737 W. GREEN MEADOWS DRIVE, SUITE 300, GREENFIELD, IN, 46140, US

(21) Appl. No.: 12/396,869

(22) Filed: Mar. 3, 2009

Related U.S. Application Data
(60) Provisional application No. 61/033,609, filed on Mar. 4, 2008.

(51) Int. Cl. G06F 12/14; G06F 17/30; G06F 12/16

(52) U.S. Cl. 707/9; 707/10; 707/E17.009; 707/E17.032

(57) ABSTRACT

An illustrative system includes a FileEngine data safety appliance and FileSafe service provides a low-cost and service rich server environment for small businesses, including shared data storage, data security and privacy, and data protection. The system can be provided under a rental contract with no purchase option, under which the vendor carries the risks associated with service and repair or replacement of the hardware and associated software. The system integrates all elements of acquiring and employing a network file server, including for example, financing, configuration, installation, file sharing, unlimited users, security, privacy, monitoring, proactive support, warranty and disaster or selected data recovery. The system provides multiple and redundant forms of data protection, for example, RAID, writeable DVD, tape backup, daily snapshots, deleted file recovery, and offsite backup. The system includes features such as configuration and deployment automation and remote monitoring and administration tools that facilitate mass marketing, for example, through office products dealers.

### CROSS REFERENCE TO RELATED APPLICATION

This non-provisional application claims the benefit of U.S. Provisional Application No. 61/033,609, filed Mar. 4, 2008, which is hereby incorporated by reference.

### BACKGROUND

The present invention relates to information technology devices, and particularly, to network files servers, and may comprise one or more of the following features or combinations thereof.

As information has become the currency of commerce, businesses have come to rely more on Information Technology (“IT”) assets. Even in small businesses, IT can be used to improve employee productivity. Alternatively or additionally, businesses may find it necessary to employ central, networked IT assets in order to share data, for example, word processing documents, spreadsheets, databases, accounting information, presentations and graphic files.

As more data is stored, the impact of the risk of loss increases because work product and information regarding customers, suppliers and employees are more central to the daily conduct of the business. Also, it is not very practical to secure critical company data on an individual user's computer. Additionally, individual user's computers offer little protection in the way of data privacy. For these and other reasons, it often becomes necessary for even small businesses to utilize a central data system, for example, a data safety appliance, network server, or file server that automates data backup and that assigns permissions for user access to some, but not all data.

File servers are a common storage device on a network that provide shared but restricted access to data. Generally file servers require a highly skilled technician to provide configuration and installation on an existing network. For example, various parameters entered into network set-up forms require a user to be highly trained, e.g., someone who knows how the server operates and understands IP addresses and the concept of file shares and groups. Thus, the way servers are presently configured is unfortunately generally costly or even cost prohibitive for many small businesses.

Unlike large enterprises, nearly six million US businesses with fewer than 50 employees typically have neither the IT staff nor the capital to invest in typical network servers, lack the skill required to setup and manage such systems, and find it difficult to bear the cost and/or risk associated with unexpected support, maintenance and replacement expenses. While most large businesses can afford to chase the promise of increased productivity that network servers provide, most small business IT decisions are driven by fears associated with IT problems and data loss. Risks include deletion or corruption of information through simple mistakes or system problems, being overcharged by consultants for IT system repairs and maintenance, disclosure of confidential information, file and system damage from viruses, and running afoul of complex software licensing schemes.

Typical network server vendors promote and provide only complex products that are generally licensed on a per-user basis. Current file server products are widely perceived to be maintenance hungry and a target for mischief. Indeed, some vendors recommend that resellers/partners charge more for after-sale service and support of file servers than the acquisition cost of the hardware. IT staff supporting network servers, for example, Microsoft Windows Servers, typically must manage frequent software patches and service packs to keep systems up-to-date and protected from new viruses and other security threats. Additionally, disaster recovery for typical network servers can easily require 20 or more hours of work by highly skilled and costly IT staff. While such network servers offer many features, the costs and complexity associated with them make it difficult if not infeasible for small businesses to purchase and maintain such systems.

Many of the features offered by typical feature rich network servers are not needed by small business, or, where needed, better value options are available. For example, for E-Mail and other collaboration services where hosted solutions are typically better for small businesses. Prices typically range from $6-$12 per mailbox per month for hosted Microsoft Exchange solutions, including support, Microsoft Outlook 2003 client software, Microsoft Outlook Web Access, Virus/Spam filtering, and backup. For Internet Filtering, inexpensive proxy filters are generally more secure. For Virtual Private Network (“VPN”) Services, inexpensive VPN appliances provide a variety of secure VPN termination types that cost less and are inherently more secure. For Web Hosting, thousands of low cost/dedicated web hosting providers have commoditized web hosting services. For File Transfer Protocol (“FTP”) Services, web hosting providers typically make this service available for a small additional charge. Inexpensive ‘Internet file courier’ services are a available too. For Internet Gateways, inexpensive and reliable commodity routers are available. Small business customers usually don't have publicly accessible services hosted on their local area network so intrusion detection is likely not needed. For Firewalls, commodity routers perform the same role less expensively and more effectively. For Wireless Access, inexpensive wireless access points can be deployed where needed—which is typically not near the server.

At the low end, Network Attached Storage (“NAS”) devices offer a low cost alternative to network servers and also offer shared storage of relative large amounts of data; however, such devices generally lack security, backup, administration and monitoring capabilities. For example, NAS devices do not provide disaster recovery that protect against and quickly overcome catastrophes like drive failure, fire, flood or theft that alternative removable or offsite backup storage offers. Additionally, NAS devices do not provide data snapshots that defend against accidental or malicious file overwriting, file corruption or other such limited disaster recovery.

Therefore, there is a need in between the complex, costly, full-featured network servers and the low cost, feature poor storage devices. For example, there is a need for a server that provides only the features typically required by small businesses in a low cost, service rich package.

### SUMMARY

In one illustrative embodiment of the invention, a FileEngine data safety appliance provides design features that trade the costs and risks inherent in a feature rich file server environment for a low-cost and service rich data safety environment. The illustrative FileEngine data safety appliance provides a superior value proposition for small businesses, for example, those operating 30 or fewer personal computers (“PCs”) that simply need shared data storage, data security and privacy, and data protection.

The illustrative FileEngine data safety appliance is referred to as a ‘data safety appliance’ because it uses a data appliance design and service approach and various data safety features. Typical of appliances, the FileEngine data safety appliance has no user serviceable parts. Additionally, other than supplying new backup media if needed, the data safety appliance is service free for users. Also typical of appliances, the illustrative FileEngine data safety appliance provides only the services and features small businesses typically require, allowing the FileEngine data safety appliance to be deployed and supported at a fraction of the cost and difficulty typical for full-featured servers. Also, for server features not provided by the illustrative FileEngine data safety appliance, for example, e-mail, collaboration and web hosting, small businesses or other customers can utilize Internet hosted services to selectively dovetail features with the FileEngine data safety appliance at a lower cost and likely more reliable alternative to the often unpredictable costs and difficulties associated with complex, feature rich servers.

In one illustrative embodiment of the invention, an illustrative FileEngine system is provided under a Service Agreement and/or Rental Contract with no purchase option. The illustrative system includes a FileEngine data safety appliance and an associated FileSafe service program. Thus, the illustrative FileEngine provides fixed, low cost rental of shared data storage, data security and privacy, and data protection. Because the hardware is rented by the Customer, rather than owned, the Vendor providing the FileEngine data safety appliance carries the risks associated with service and repair or replacement of the hardware and associated software.

The features of the illustrative FileEngine data safety appliance enable competitive package prices for equipment and installation, plus competitive maintenance and service costs. For example, the FileEngine data safety appliance hardware can be provided free in exchange for a paid subscription to the FileSafe program, for example, for just dollars a day. Additionally, the illustrative FileEngine system integrates all elements of acquiring and employing a network data safety appliance, including for example, financing, configuration, installation, file sharing, unlimited users, security, privacy, monitoring, proactive support, warranty and disaster or selected data recovery. The illustrative embodiments are less complex to install and support and less expensive than typical network file servers.

The illustrative FileEngine data safety appliance is especially advantageous for small businesses, schools and not-for-profits that lack an IT staff and require a low and predictable cost solution. Such prospective Customers typically have, for example, 4-30 PCs. Particular features of the illustrative FileEngine data safety appliance combine to provide these advantages, including, for example, utilizing Linux as its operating system and certain Open Source Software. Additionally, by standardizing and minimizing possible configurations and aggregating thousands of the FileEngine data safety appliances, service delivery costs are economized.

The illustrative FileEngine data safety appliance includes features such as deployment automation and remote monitoring and administration tools that facilitate mass marketing, for example, through office products dealers. These features are provided by infrastructure elements of the FileEngine system, including, for example, automated order processing, secure remote administration, monitoring, desktop PC integration, offsite backup, control panel electronics and firmware, end-user documentation and reseller training materials, legal documentation, advertising materials, website content and the like.

Costs associated with implementing complex, feature rich servers are sometimes unpredictable. For example, often there is no documentation of how a network was configured, so a skilled technician must conduct an onsite survey to understand the existing network components and what files are to be shared. Even when a skilled technician completes a site survey, errors in recording IP addresses, file shares, or the like can be easily made and very difficult to locate or repair.

To solve these and other problems, the illustrative system provides an innovative way to deploy, maintain, employ and service file servers. For example, using automated and/or assisted configuration tools, a person of common knowledge can configure a FileEngine data safety appliance, perhaps a business owner or a person in an office that is slightly more technically adept than an average computer user, whether trained or not. One of the advantageous features of the illustrative FileEngine is that because information collection is automated and/or assisted, errors in the configuration information are minimized.

An illustrative system delivers all system and security updates for the FileEngine data safety appliance automatically through a remote administration system. In fact, an illustrative FileEngine data safety appliance does not have a keyboard, monitor or mouse, thus increasing security and the possibility that a user will unintentionally damage configuration settings, data, or backups.

An illustrative FileEngine data safety appliance includes Novel SUSE Linux Enterprise Server with an Open Source License, enabling free expansion of users without additional cost or fear of prosecution for license compliance violations.

An illustrative system includes the initial expense of configuring and installing the server and the ongoing expense and risk of monitoring and repair or replacement in a low fixed monthly fee, making the total cost of ownership and employment predictable and a fraction of alternative systems.

An illustrative system integrates all aspects of server acquisition and employment into a single Vendor value proposition, including for example, financing, pre-configuration, shipping, installation, unlimited users, file sharing, security, privacy, monitoring, proactive and unlimited server support, warranty and disaster recovery. For example, the system can provide multiple and redundant forms of data protection.

The illustrative FileEngine data safety appliance supports Windows NT-Domain logins, drive mappings, and automated creation of login-scripts, as well as creation of Users, Groups and File Storage Areas that manage Read-Only, Read-Write or denial of access to files. The illustrative FileEngine data safety appliance is also Microsoft Windows and Apple Computer Mac OS compatible. The system is also compatible with existing Microsoft Windows Active Directory managed networks.

An illustrative FileEngine data safety appliance provides disaster recovery, print server functionality, including automatic PDF conversion, implemented as a Postscript printer driver, and full replacement warranty including restoration of data from backups. Remote administration is secure and connections are established from the inside out so that neither configuration of network hardware nor static public IP addresses are required. Remote administration includes monitoring of backups, hard drive space, UPS protection, and other performance parameters.

Automatic backups can be made, for example to dual-layer DVDs (“DVD-DL”), and the DVD device tray opens when a new DVD is required and to indicate visually that the backup was successful. The system provides instant restore availability from backup DVD and offsite backups. The system provides one day repair or swap-out replacement in the event of hardware failure. With sufficient economies of scale, it is believed an illustrative FileEngine system can be profitably delivered for as little as $99/month (US dollars 2007).

An illustrative FileEngine system comprises software, including for example, administration tools utilizing Microsoft Windows Win32, User/Group/File Storage Area management tools, a DVD-DL Backup recovery utility for Windows PCs, a Connection Wizard to automate Microsoft Windows profile migrations, integrated and secure offsite storage that supports multiple generations of backups, availability of local IT Partners that have completed specialized training in FileEngine data safety appliance technology, contracting, pre-configuration, installation, service and support.

These and additional features of the disclosure will become apparent to those skilled in the art upon consideration of the following detailed description of the illustrative embodiments.

### BRIEF DESCRIPTION OF THE DRAWINGS

FIG. 1 is a schematic block diagram illustrating a network environment incorporating a FileEngine data safety appliance and FileSafe service infrastructure according to the present invention;

FIG. 2 is a schematic block diagram illustrating the FileEngine data safety appliance of FIG. 1;

FIG. 3 is a schematic block diagram illustrating the FileSafe service infrastructure of FIG. 1;

FIG. 4 is a flow chart illustrating an acquisition and deployment method associated with the FileEngine data safety appliance and network environment of FIG. 1;

FIG. 5 is a flow chart illustrating the pre-configuration portion of the acquisition and deployment process of FIG. 4; and

FIG. 6A-6F are computer screenshots for a web-based application used to collect pre-configuration information according to the processes illustrated in FIGS. 4 and 5.

### DESCRIPTION OF THE ILLUSTRATIVE EMBODIMENTS

For the purposes of promoting and understanding the principles of the invention, reference will now be made to one or more illustrative embodiments illustrated in the drawings and specific language will be used to describe the same. It will nevertheless be understood that no limitation of the scope of the invention is thereby intended.

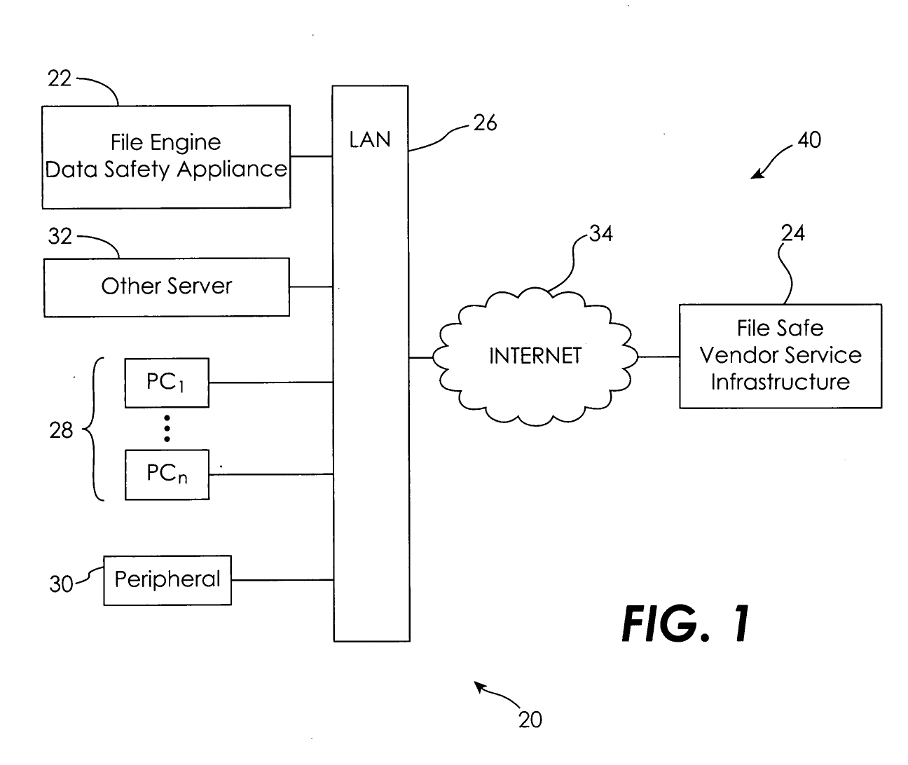

Referring to FIG. 1, a network environment 20 incorporating a FileEngine data safety appliance 22 and FileSafe data safety services infrastructure 24 according to the present invention is illustrated. The FileEngine data safety appliance 22 is coupled to a Customer's local area network (“LAN”) 26. The LAN 26 may include devices such as network switches, routers, gateways and the like. Also attached to the LAN are PCs 28, and other network attached devices, for example, printers 30 and other servers 32. The LAN 26 is generally attached to one or more wide area networks (“WAN”), for example, the Internet 34. Communication between the FileSafe data safety services infrastructure 24 and the FileEngine data safety appliance 22 and other network environment 20 devices, for example the PCs 28, is provided by the Internet 34 and the LAN 26 utilizing secure communications protocols such as those known in the art. PCs 28 may a client processor capable of data transfer over LAN 26, including personal computers, for example Windows, Apple, Linux, and Thin Client systems.

Integrated System

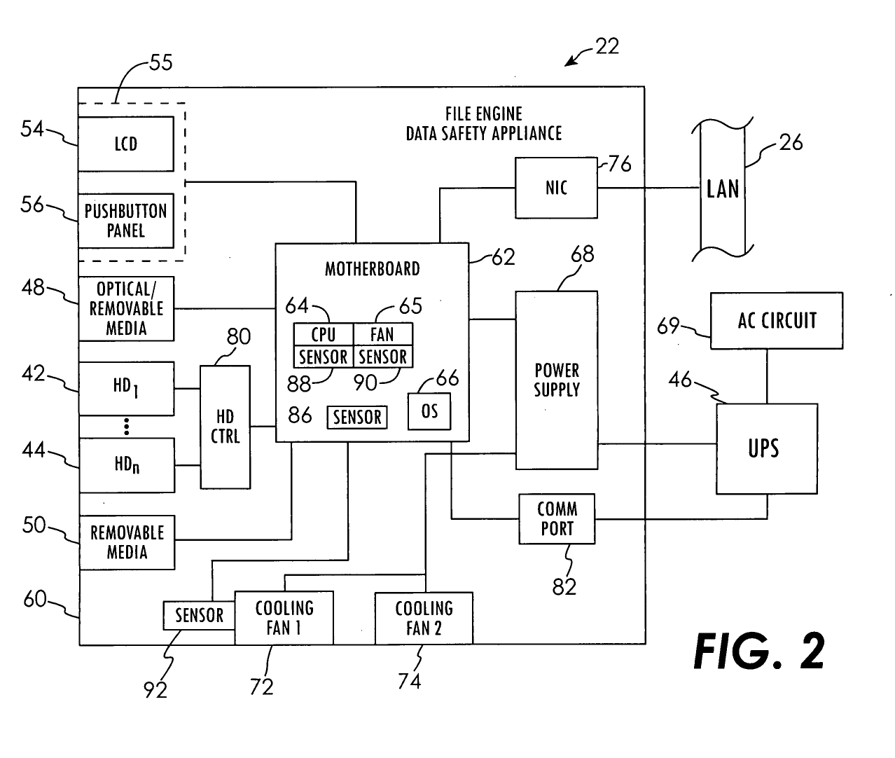

The illustrative system 40 includes the FileEngine data safety appliance 22 and the FileSafe data safety services infrastructure 24. The system 40 is an integrated hardware, software, and service solution that is completely equipped with all of the components necessary to fully provide reliable file serving on a Customer's LAN 26. For example, in the illustrative system 40, a single hardware box, the FileEngine data safety appliance 22 (FIG. 2), includes redundant and fault tolerant shared data storage area 42 and 44, an uninterruptible power supply (“UPS”) 46, and backup media device(s) 48 and 50 for automatic creation of backup media. The data safety appliance 22 allows selected user folders to be redirect from individual PCs 28 to the appliance data storage area 42 and 44, thus enabling sharing, fault tolerance, and backup protection for the selected user folders.

Advantageously, the hardware portion of the data safety appliance 22 can be provided for free with a service contract. The software and service portion of the system 40 provides integrated and automatic local and remotely located backup. System administration of the FileEngine data safety appliance 22 is remotely managed by the FileSafe data safety services 24, including the Vendor IT staff, using key-based and encrypted remote access. Thus, ongoing system administration of the FileEngine data safety appliance by the end-user is little to nonexistent. For example, the FileSafe data safety services 24 includes remote administration, telephone support & diagnostics, warranty repairs, replacement (including data recovery from backups,) and on-site service, if required.

The data safety appliance 22 is typically delivered without local console access, e.g, no keyboard, monitor, or pointing device can be connected to the FileEngine data safety appliance because it has no user serviceable configuration options or parts. The FileEngine data safety appliance box may include an optional user interface 55, for example, an LCD 54 and four pushbutton switches 56 that give users access to only those features that they need to have access to, thus limiting the likelihood of a user creating problems with the data safety appliance. For example, users are limited to shutting the power off, initiating a gateway connection to the Internet, creating and restoring backups, creating “Takeout” media, performing simple maintenance functions and tests, and completing a disaster recovery. Alternatively, the user interface 55 may be a touch screen, or other interface, or the data safety appliance 22 may include a locally or remotely hosted web based user interface or no user interface 55.

Data security and privacy is also provided by the system 40. The FileEngine data safety appliance incorporates ‘Domain Controller’ functionality that restricts access to the files it stores to authorized domain users. For example, business owners generally want to keep some of the data they store confidential from other users. This is principally accomplished by logins and passwords. When users login at their PC 28, they can be identified as a member of one or more groups, each of which have been assigned access rights, for example, None, Read-Only or Full access, to File Storage Areas (“FSAs”) on the data safety appliance 22. In some network environments 20, once a PC 28 has been configured to login to the FileEngine data safety appliance 22 controlled domain, only authorized users can even use the PC.

FileEngine Data Safety Appliance Features

Hardware options for typical prior art servers offer hundreds or even thousands of different possible configurations from a single vendor. By providing only a few different possible configurations, an illustrative embodiment of the FileEngine data safety appliance 22 can provide the typical range of options needed for the target customers. Thus, reducing costs, speeding manufacturing and deployment, and simplifying support and repair or replacement.

An illustrative embodiment of the FileEngine data safety appliance 22 case can include one or more of the following elements in combination in a single or distributed package:

a mini-tower or rack mount unit, aluminum for efficient heat transfer, and may be painted fire engine red 60;

a PC motherboard 62, for example a with RAM, a 2.4 Ghz Intel Pentium P4 CPU 64, and CPU fan 65, for example, such as those motherboards available from ASUS;

a Linux operating system 66, for example SUSE Linux Enterprise Server available from Novell;

an extra-rated power supply, for example, a 400 W power supply 68, typically powered by a 110 VAC circuit 69

dual cooling fans 72 and 74;

a 620 VA UPS 46;

an Ethernet network interface card (“NIC”) 76;

a four line LCD panel 54;

a four pushbutton switch panel 56;

a fault tolerant/redundant data storage subsystem, for example, an array of hard drives 42 and 44, for example providing 25, 100, or 200 GB or more of data storage, for example available from Western Digital, and controlled by a SATA RAID controller 80, for example, available from 3Ware;

a first removable media drive, for example an optical drive such as a writeable dual layer DVD drive 48, for example offering approximately 12 GB compressed data storage capacity;

a second removable media drive, for example, a DLT V4 tape drive 50, for example offering up to 320 GB compressed data storage capacity; and

a communication port 82 for providing communication with the UPS 46.

The FileEngine data safety appliance 22 can serve as the only server in typical small business network environment 20 (FIG. 1); however, for those businesses requiring additional features not offered by the FileEngine data safety appliance, a second server 32 can be used. For example, a Microsoft Windows server could be coupled to LAN 26 to implement Exchange email, Outlook calendars, or the like. Such an implementation still provides the small business with the low cost, service rich, and reliability advantages of the FileEngine data safety appliance system 40.

Acquisition and Deployment

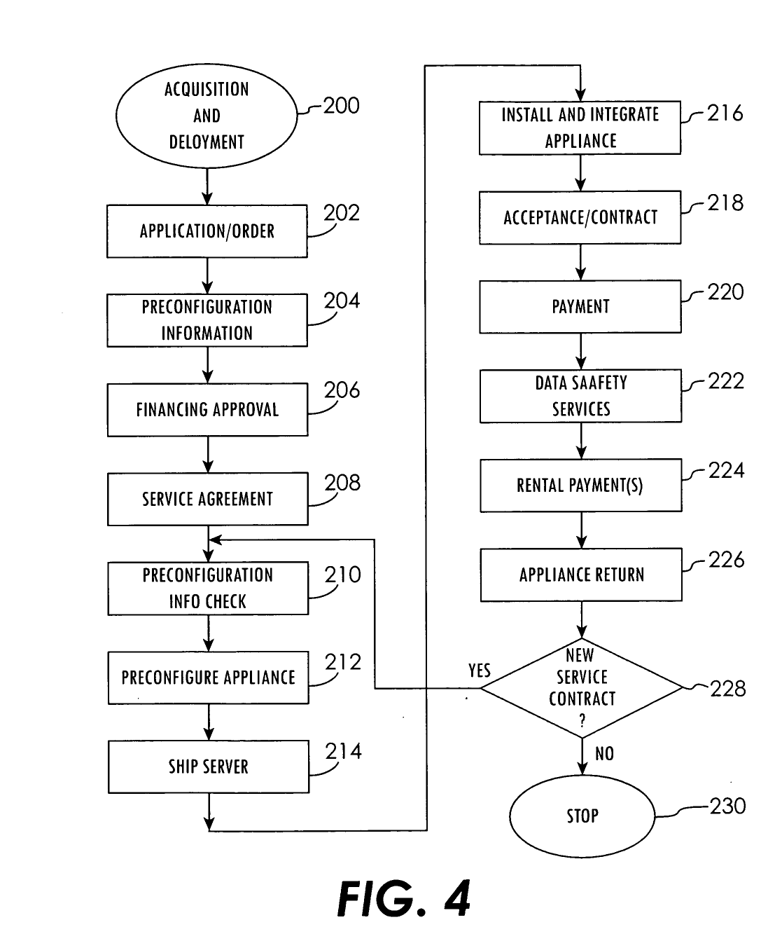

The FileEngine system 40 provides innovative methods of configuring and deploying servers. For example, as shown in FIG. 4, an illustrative method 200 for configuring and deploying a FileEngine data safety appliance 22 in network environment 20 is shown. The steps associated with method 200 may include one or more of the following steps executed in the illustrated or alternative orders.

A Customer 100 desiring to acquire a FileEngine data safety appliance 22 and associated FileSafe data safety services 24, for example from the Vendor 102 or an IT Partner 104, first completes and returns an Initial Application/Order 106 at step 202, for example to the Vendor 102 or to a Finance Partner 108. For example, in order for the Customer 100 to obtain a FileEngine data safety appliance 22 with little or no money down, an Initial Application/Order 106 comprising a basic credit application is submitted to a Finance Partner 108. For example, a suitable Finance Partner 108 may include a financial provider capable of providing rapid application approval, for example overnight or immediate, and advance payment against a Rental Contract 110 to the Vendor 102 and/or IT Partner 104. For example, suitable Finance Partners 108 include Dolphin Capital. For example, Rental Contract 110 can assign warranty obligations to Vendor 102 and payment obligations to Customer 100.

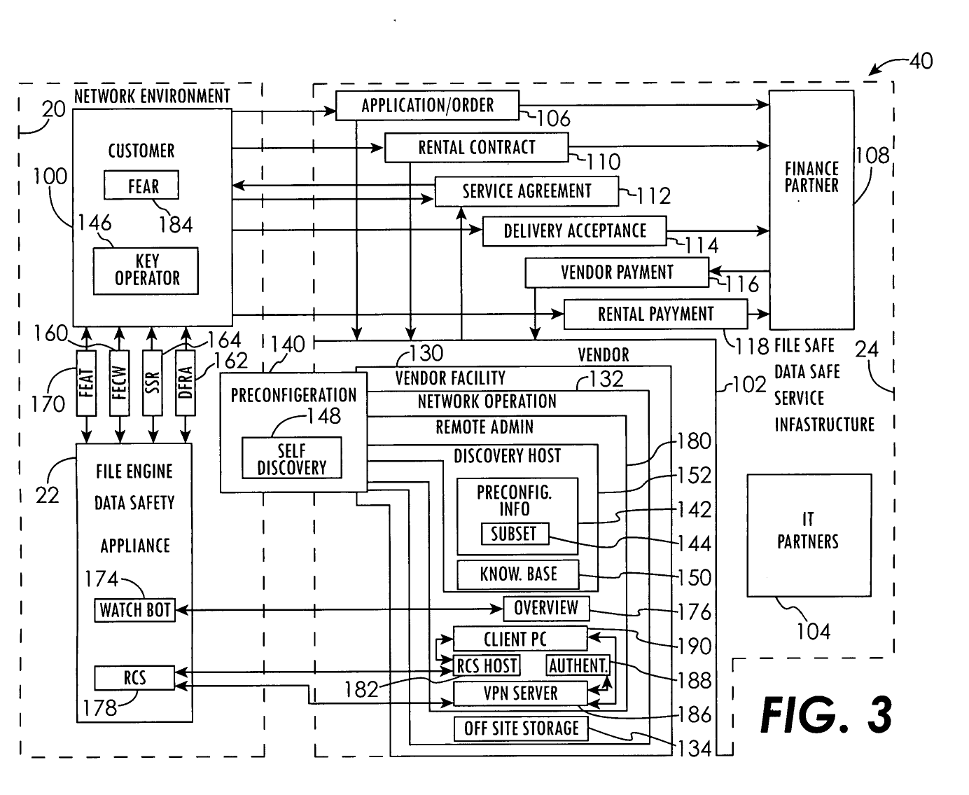

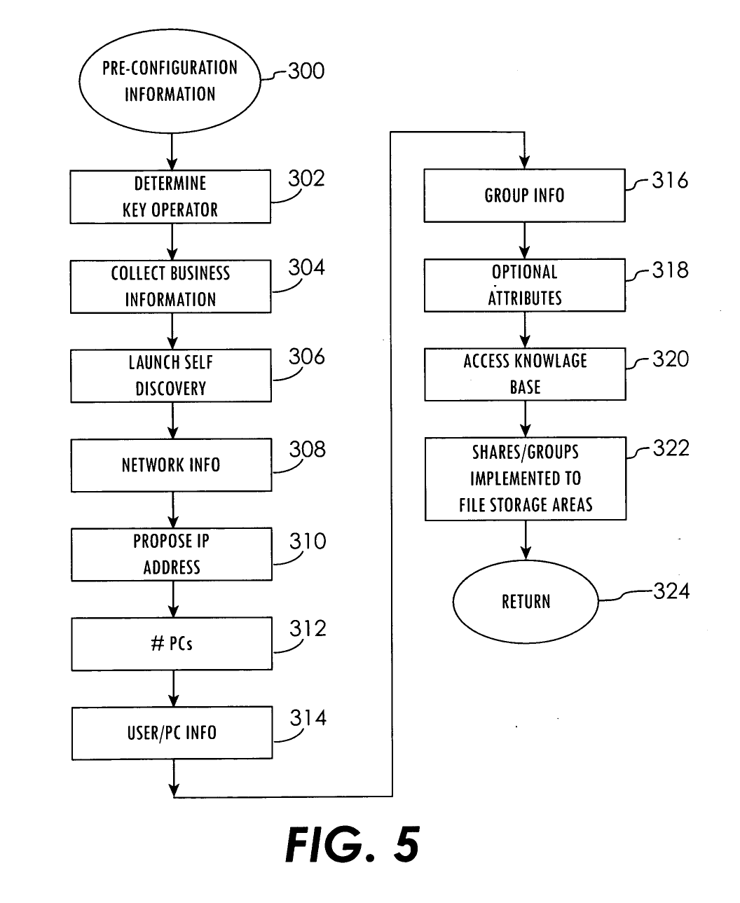

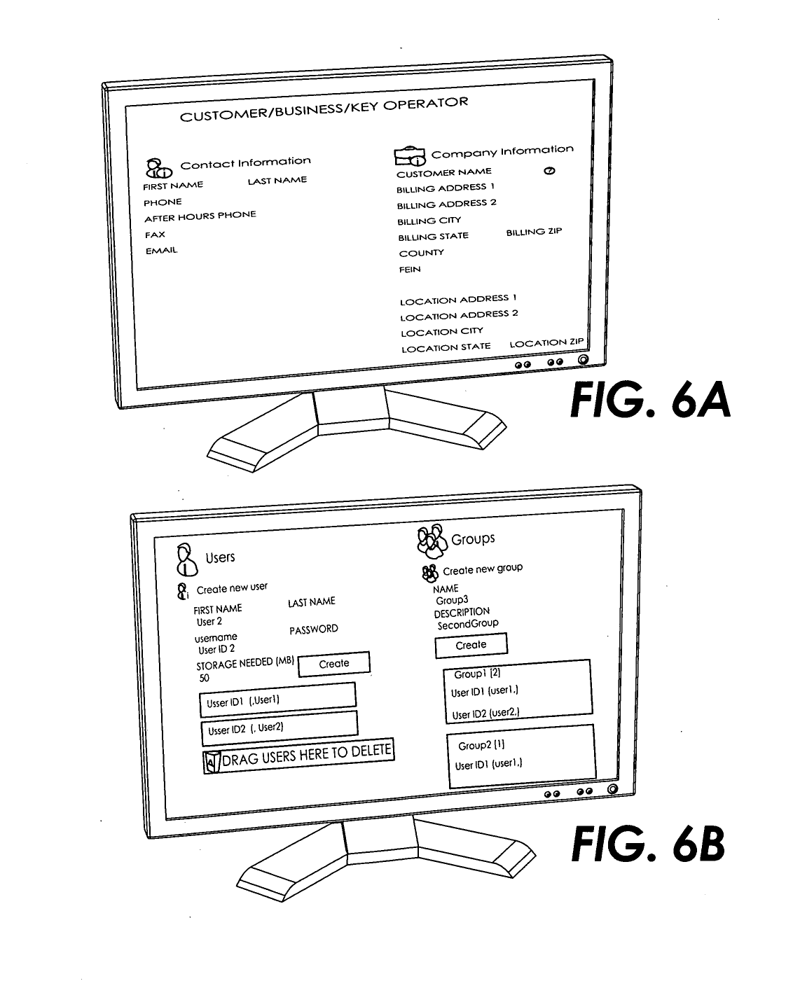

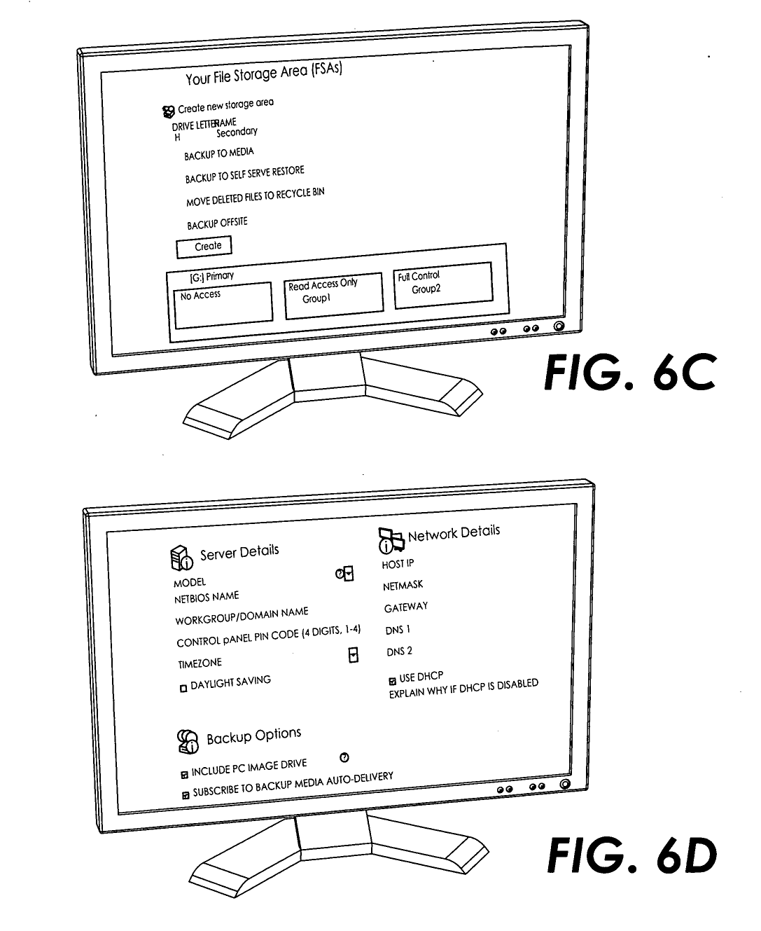

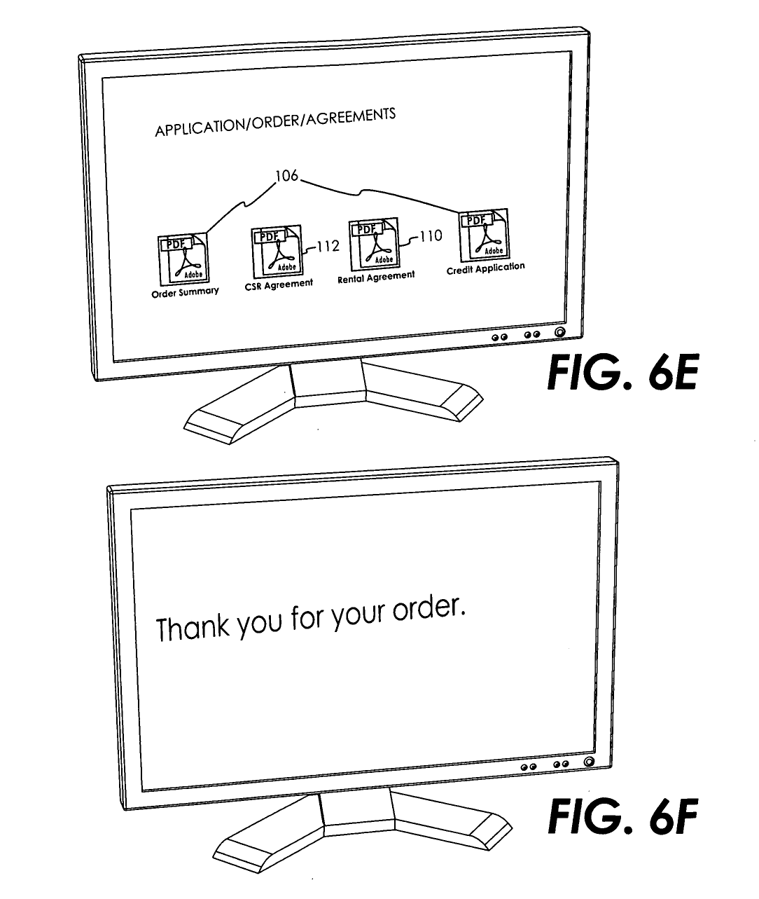

The Customer 100, IT Partner 104, or Vendor 102 can begin pre-configuration of the data safety appliance 22 at step 204, for example, while financing approval is pending. For example, step 204 can begin Pre-Configuration Method 300 (FIG. 5), described below, which may include a downloadable self-discovery tool 148 (FIG. 3) and web-based means of specifying business relationship details and/or characteristics of the network environment on a simplified basis, for example, such as the illustrative information collection web forms shown in FIGS. 6A-6F. Upon completion of step 204 and approval of the Initial Application/Order 106 at step 206, the Customer 100 at step 208 next completes and returns a Service Agreement 112, for example, to the Vendor 102. For example, Service Agreement 112 assigns service obligations to the Vendor 102 and compliance with terms of service to the Customer 100.

After receipt of the Service Agreement 112, at step 210 the Vendor 102 or IT Partner 104 checks and, if required, corrects the pre-configuration information developed at step 204. At step 212 the Vendor 102 or IT Partner 104 pre-configures a FileEngine data safety appliance 22. Pre-configuration is a manufacturing system that automates production of the data safety appliance 22 according to the pre-configuration information 142 obtained at step 204. For example, the manufacturing system assures quality and consistency with a minimum of network environment familiarity, saves manufacturing time, and reduces onsite delivery burden: time, skill level, and risk. For example, step 21 can include laying down a Linux image on RAID 42 and 44 of an already manufactured and in stock data safety appliance 22, for example as is described in Section 2 of the attached Key Operator's Guide.

After pre-configuration, the data safety appliance 22 is shipped in step 214 to the Customer 100 or to the IT Partner 104. Alternatively or additionally, the data safety appliance 22 can be shipped to the Customer 100 or IT Partner 104 before it is pre-configured and pre-configuration can be later completed using an partially or fully automated locally or remotely controlled process.

In step 216, the FileEngine data safety appliance 22 is installed and integrated into the network environment 20, for example, by the IT Partner 104 or the Customer 100. Installation includes, for example, coupling the data safety appliance 22 to LAN 26, joining PCs 28 to the domain, migrating selected data files from the PCs 28 to the data safety appliance 22, and testing and problem resolution, if required. After installation step 216 is complete, at step 218 the Customer completes and returns the Rental Contract 110 and Acceptance of Delivery 114, for example, to the Finance Partner 108.

After receipt of the Rental Contract 110 and Acceptance of Delivery 114, and/or other confirmation of installation of the FileEngine data safety appliance 22, at step 220 the Finance Partner 108 transmits a Payment 116, for example, to the Vendor 102, and if applicable, to the IT Partner 104. At step 222, the Vendor 102, and if applicable, the IT Partner 104 continue providing FileSafe data safety services 24 to the Customer 100 acquiring the data safety appliance 22, for example, in accordance with the Service Agreement 112. At step 224, the Customer 100 makes a payment or a series of periodic payments, for example, monthly Rental Payments 118, for example, in accordance with the Rental Contract 100, to the Finance Partner 108.

In step 226, at the term expiration of the Rental Contract 110 Customer 100 returns the data safety appliance 22, for example to the Vendor 102 or the IT Partner 104. In step 228, if a new Rental/Service Contract 110 is executed, a new replacement FileEngine data safety appliance is provided to Customer 100, for example, by continuing at step 210 above, for example, before or simultaneously with step 226. If a new Rental/Service Contract 110 is not executed, the algorithm ends at step 230.

Pre-Configuration

PCs and other computer hardware typically can be selectively configured online to provide the specific hardware, operating system, and software applications that are desired; however, no such pre-deployment configuration is available for a data safety appliance operating in a specific network and file sharing environment. Prior art files servers are typically configured upon deployment, for example, during onsite deployment by a certified network engineer using site survey information of the deployment network. Even then, configurations completed by skilled technicians still sometimes include errors that further delay full deployment of a file server or that cause subsequent maintenance, security, or reliability issues.

In contrast, the FileEngine data safety appliance are typically configured, or rather pre-configured, at step 204, after manufacturing but before shipping at step 214 and installation at step 216. One motivation for pre-configuration is that if good information can be collected, quality control of data safety appliance configuration is more effectively controlled at the Vendor's facilities 130 (FIG. 3) than at the onsite location of a Customer's network environment 20. Another motivation for pre-configuration is to achieve cost savings and economy by minimizing onsite work and skilled technician time.

The illustrative system provides pre-configuration by using a Pre-configuration Tool 140 that automates or partially automates the process of collecting site survey and pre-configuration information 142. For example, the Pre-configuration Tool 140 can include a FileEngine Administration Tool (“FEAT”) 170 (further described below) that comprises a simple to use Win32 application to gather pre-configuration information 142, for example, including the web forms illustrated in FIGS. 6A-6F. For example, pre-configuration information 142 developed by the Pre-configuration Tool 140 can include parameters relating to:
Customer 100, Key Operator 146, and business information (FIG. 6A);
users, including login names, real names, and passwords, home directories, login scripts and group memberships (FIG. 6B), for example, using Lightweight Directory Access Protocol (“LDAP”) to store user information.
File Storage Areas (shares) where the shared files will be stored, including drive letter mapping and backup options including removable media, self-serve restore (“SSR”), data file recovery, and offsite (FIG. 6C);
groups that share permissions to access directories of data, including no access, read-only access and read and write access (FIG. 6D);
server parameters and network parameters for the Customer's existing network that the FileEngine data safety appliance will be connected to, including server name, Host IP address, netmask, gateway, DNS and DHCP configuration, and desired backup options (FIG. 6D); and
documentation including, Order Summary/Credit Application 106, Rental Agreement 110, and Service Agreement 112.

The Pre-configuration Tool 140 reduces the risk of mistakes, conserves skilled IT technician time and deployment time saving the Customer 100 productivity, and produces consistent results with varied skill levels. In one illustrative embodiment of the system 40, a Pre-configuration Tool 140 collects all the information 142 required to configure an illustrative embodiment of the FileEngine data safety appliance 22 for deployment in the Customer's particular network environment 20. In one illustrative embodiment, a web-based Pre-configuration Tool 140 (for example, FIGS. 6A-6F) walks an IT Partner 104 or Key Operator 146 through various steps that result in determination of the FileEngine data safety appliance configuration. For example, the Key Operator 146 is a single designated individual user who is employed by Customer 100. The Key Operator 146 need not have specialized IT training or experience.

It is desirable that the data safety appliance configuration based on the Pre-configuration Tool 140 has a very high likelihood of providing a data safety appliance 22 configured to work in that particular small business network environment 20. Rather than using a configuration system of forms that require specialized knowledge to fill, an illustrative Pre-configuration Tool 140 uses interview style questions to guide the user through the process, thus collecting the required information associated with the Customer's network environment 20 and PCs 28 and uploading that information via WAN 34 to the Vendor Facility 130. Thus, the Pre-configuration Tool 140 can significantly reduce the technical skill required to configure a data safety appliance 22.

Another embodiment of the Pre-configuration Tool 140 asks interview style questions only for a subset 144 of information 142. For example, the interview can be completed by each PC user, the Key Operator 146, or the IT Partner 104. The subset information 144 then enables automatic collection of the remaining technical information 142 required for configuration of the FileEngine data safety appliance 22.

For example, an illustrative pre-configuration method 300 associated with the Pre-configuration Tool 140 is illustrated in FIG. 5. In an illustrative method, web forms such as those illustrated in FIGS. 6A-6F are utilized at various steps of method 300.

In step 302, the method 300 begins the interview style collection of information by collecting administrator information, for example, whether a Key Operator 146, IT Partner 104, or each individual user will be entering subset pre-configuration information 144. Step 304 collects business information relating to Customer 100, for example, that required to complete Application 106, for example a credit application, Rental Contract 110, and Service Agreement 112.

In step 306, the self discovery function 148 is launched, which can include accessing the Knowledge Base 150. In step 308, basic information about the network environment 20 is collected, for example, the type of LAN 26 and identity of the Other Servers 32. Step 308 may include using the self discovery function 148 to collect the information. In step 310, the method 300 proposes additional pre-configuration information 142, for example, based on the information 142 collected so far and access to data and/or functions of the Knowledge Base 150. For example, step 310 may propose an IP address for the data safety appliance 22.

Step 312 collects basic information about the PCs to be joined, for example, the number of PCs 28 existing on LAN 26, including using the self discovery function 148. Step 314 collects basic user information about the users, for example, the identity of each user, what the login and password for each user should be, and PC related pre-configuration information, including using the self discovery function 148 to obtain the user and PC information. Step 316 collects group information, for example, creation of groups based on data sharing requirements and assignment of users to groups.

Step 318 collects additional optional attributes about the network environment 20, for example, particular aspects of the LAN 26, PCs 28, applications, and the like, which combined with a Knowledge Base 150 (FIG. 3), can be used to further optimize and/or automate the pre-configuration discovery method 300. In step 320 the method 300 accesses the Knowledge Base 150 based on the collected subset information 144 and determines an remaining information and/or methods associated with a self-discovery function 148 that is tailored for the particular LAN 26, PCs 28, applications, files, and the like.

The discovery function 148 that may be utilized in various steps, for example steps 306-320, can utilize self discovery methods, including PC and network path crawling known in the art. Upon completion of the discovery function 148, all information 142 required for pre-configuration of the data safety appliance 22 is typically available. The self discovery function 148 allows even unskilled users to develop the configuration information 142 while minimizing or eliminating errors. For example, typical users of PCs don't know how to find the disk space they are using, what programs they are using, and also don't know what network file shares and groups are; however, the Pre-configuration Tool 140 can automatically discover the required information 142.

In step 322, the information collected and/or determined for shares and group assignments are implemented to the FSA. In step 324, the method 300 ends and returns to the Acquisition and Deployment method 200 at step 206. Additionally, or alternatively, the method 300 may include a subset of the steps 302-322, additional steps, and the steps 302-324 may be executed in a different order than shown in FIG. 5.

Another illustrative embodiment of the Pre-configuration Tool 140 is a downloadable application that the user can self install and execute on a user's PC 28. For example, a user can locate the downloadable application using a provided Internet link, for example a link provided by email or by entry of a code or login/password combination on the Vendor's Website 158.

This illustrative embodiment of the Pre-configuration Tool 140 may also rely simply on crawling and other self discovery functions 148, as well as the Knowledge Base 150 of typical hardware and software systems in order to fully crawl and develop all pre-configuration information 142. The pre-configuration information 142 can then be supplemented or revised as desired, for example, in step 210 of method 200 discussed above. For example, the automated discovery process 148 can be run from a single PC 28 acting as a host on the LAN 26. Executing the Pre-configuration Tool 140 on one PC 28 of the LAN 26 can enable the discovery function 148 of the Pre-configuration Tool to crawl and query every PC 28 on the LAN 26 and to obtain all the required pre-configuration information 142.

Alternatively, rather than collecting all the pre-configuration information 142 required to be collected about the whole network all at once, the Pre-configuration Tool 140 can be executed at each PC 28 and interview and/or automatically discover function 148 can collect configuration information for each PC and user. Additionally or alternatively, a Pre-configuration Tool 140 running on one or each PC 28 can broadcast to a Discovery Host 152 located on or located outside of the local network, for example at the Vendor Facilities 130. For example, the Pre-configuration Tool 140 may utilize remote access to individual PCs 28.

Regardless of the particular embodiment utilized, the information 142 collected by the Pre-configuration Tool 140 includes, for example, file names, data sizes, how much data is in particular folders, and all IP information, including the host PC's IP gateway address, determination if the gateway's Internet address is static or dynamic, the DHCP server if there is one, and if DHCP, every host on the LAN 26. The Pre-configuration Tool 140 can propose an IP address for the FileEngine data safety appliance 22 based on the information gathered, including by the self discovery function 148; however, the IP address would still need to be confirmed. The Knowledge Base 150 associated with the discovery function 148 enables recognition of common network environments, applications, and user files, for example, so that program files and user files associated with each application can be automatically located and identified rather than having to manually specify such parameters, including file names and locations. As the Pre-configuration Tool 140 crawls through each PC 28, it discovers and stores and/or broadcasts user lists, directory sizes for each profile, and files and locations associated with installed applications.

Known applications utilizing crawling technology related to that used for the self discovery function 148 include IT asset management applications used to identify and report on IT systems and software associated with a network. Such applications identify network and PC hardware and software features, for example, what OS its running, how much RAM is installed, what software is installed, the physical hard drive storage size. Two examples are Microsoft SMS and ASAP Software. Such applications typically use client software installed on each PC that initiates and broadcasts the information. In contrast, one illustrative embodiment of the Pre-configuration Tool 140 initiates information gathering from a Discovery Host 152 rather than from each PC 28.

Network firewalls (not shown) may need to be taken into account; however, they do not provide an insurmountable obstacle because the Pre-configuration Tool 140 can operate and crawl from inside the LAN 26 rather than from outside a network firewall or other network security device. However, firewalls and antivirus software on individual PCs 28 may need to be temporarily disabled unless a client application that initiates communication to the Discovery Host 152 is installed on each PC 28.

The information 142 collected can be aggregated to the Vendor Facility 130 using the Internet 34, or collected on a single PC for later transmission. For example, the collected information 142 can be organized by the Pre-configuration Tool 140 into a data package, for example, an XML file, and then uploaded by the Discovery Host 152, for example, at the Vendor Facility 130.

The illustrative Pre-configuration Tool 140 and other features of the illustrative system 40 turn data safety appliances into a commodity appliance that can be delivered to a mass market with little to no technical expertise required by a Customer 100 purchasing and self installing the FileEngine data safety appliance 22.

In an alternative embodiment of the system 40, the FileEngine data safety appliance 22 is provided with a basic configuration that facilitates connection to the Internet 34 at the location of the Customer's network environment 20. Once the Pre-configuration Tool 140 provides full pre-configuration information 142, pre-configuration of the FileEngine data safety appliance 22 is then completed at the Customer's location, for example, via a remote connection to the Vendor Facility 130 over the Internet 34, or by remote administration of PC's 28 using remote control techniques.

Installation

Installation, for example, as completed in step 216 of method 200, includes setup and integration of the FileEngine data safety appliance 22 onto the Customer's LAN 26, for example, as if further described in Sections 2 and 3 of the attached Key Operator's Guide. Installation also includes migrating data from individual PCs 28, for example, from local My Documents folders, to users' home directories on the data safety appliance 22. Installation also includes configuring applications that store files locally on PCs 28 to instead reference data stored on the FileEngine data safety appliance 22. Scripts can also be provided that backup a local user's E-Mail to the FileEngine data safety appliance 22, if appropriate. Installation also includes migrating user profiles from the local user to the equivalent domain user on each PC, if appropriate, or implementing “roaming profiles” as are known in the art.

PC Connection Wizard

The FileEngine system 40 can also include a FileEngine Connection Wizard (“FECW”) 160 that automates the process of connecting a Microsoft Windows PC 28 to the FileEngine data safety appliance 22 when it operates in a domain controller mode. For example, the FECW 160, for example as further described in Section 5 of the attached Key Operator's Guide, is a Win32 application that automates the process of joining networked Microsoft Windows PCs (Windows 98, 2000 and XP Pro) to the FileEngine Domain and automates migrating user profiles and files. Generally, all that need be provided is the FileEngine Domain Name, the user login name and password for the PC being joined, and the permission groups the user is to be assigned to, for example, Users, Power Users, Administrators. After the required information is entered, FECW 160 automatically joins the PC 28, including migrating appropriate files from the PC 28 to the FileEngine data safety appliance 22 and associated drive mapping.

Specifically, to connect a PC 28 to a LAN 26, particularly with respect to the allocation of permissions to access shared files, there is configuration that needs to be done at the desktop level to join the PC to the domain. This process can be a fairly complex sequence of events. The FECW 160 automates that configuration sequence of events.

Shared Storage Space

The illustrative FileEngine data safety appliance 22 uses File Storage Areas (“FSA”) rather than shares. File Storage Areas are virtual areas on the RAID 42 and 44. The FSA integrates several concepts, including an area of shared data storage, group assignable permissions to use that location (so that people who use the data safety appliance can access files from it, and how they can use it, e.g., None, Read-Only, and Full Control), backup policy and drive mapping. Unlike other servers, FSA permissions are assigned on the entire FSA by group, not individuals within groups or folders within FSAs.

In addition to the FSA, additional partitions on the RAID 42 and 44 may include, for example, Self Serve Restore (“SSR”), Restore, Takeout and Deleted File Recovery. The SSR partition provides a plurality of data snapshots, for example, multiple daily archives of data snapshots, for example data snapshots of the previous 14 days. Data stored in the SSR partition can be easily restored using a file browser application 164 discussed further below, for example, using Windows Explorer. The Restore partition is a dedicated read only FSA for full backup restore that can be initiated remotely by the Vendor 102 or IT Partner 104, or Key Operator 146 via the LCD and Pushbutton Panel 54 and 56, as is discussed further below. The Takeout partition is a dedicated FSA for creating removable media backups that can be used to conveniently transfer data from the FileEngine data safety appliance 22 to a PC, for example, a PC not coupled to LAN 26. The Deleted File Recovery Area (DFRA) partition is used for a server based recycle bin, for example, similar to that available on an individual Microsoft Windows PC 28. For example, up to 50% of user data storage space can be used for the DFRA.

Configuration Changes

In one illustrative embodiment, the FileEngine Administration Tool (“FEAT”) 170 comprises a simple to use Win32 application, for example as described in Section 4 of the attached Key Operator's Guide. From a PC 28 on LAN 26, the Customer's Key Operator or IT Partner can enter the appropriate login and password and use FEAT to modify the system configuration after initial installation. For example, FEAT 170 can provide just enough administration capability to allow Customer 100 to perform basic administration without revealing aspects of control that require enhanced skills and training or which could result in premature failure that is sometimes associated with complex servers. For example, FEAT 170 allows Customer 100 to Add/Edit/Remove Users, Groups and File Storage Areas (FSAs), to assign No-Access, Read-Only or Read-Write permissions to FSAs by group, and to select backup means. FEAT displays information for these configuration parameters, for example, using an Administrator View Report, and allows the information to be modified. Also, the FileEngine Connection Wizard (“FECW”) described above can be run on a PC which needs to be joined to the LAN 26 after installation of the FileEngine data safety appliance 22 has already been completed.

Remote Monitoring

Effective monitoring of file servers and backup systems is often a weak, non-existent, or extra cost part of prior file servers. For example, how much remaining storage space is available, whether backups are successfully created or not, CPU overheating, UPS status, Internet connectivity, and the like.

In contrast, the system 40 can include a WatchBot® Monitoring System 174 that monitors key performance parameters of the FileEngine data safety appliance 22 and regularly communicates parameters to a Vendor Network Operation Center 132. The Overview software 176 used at the Vendor Network Operation Center 132 receives data from the WatchBot Monitoring System 174 and inputs the performance data into databases for correlation, automated analysis, and alarm generation.

The Overview software 176 can also provide simple on-screen dash-panel and other forms of alerts that quickly and easily identify conditions that need further review by Vendor 103. For example, simple red light/green light indication of the status of each individual FileEngine data safety appliance 22 as well as specific causes of red light indications are provided.

Monitored conditions include backups and various performance variables, including the status of backups, operating system, available hard drive space, and other hardware. The WatchBot Monitoring System 174 is nearly firewall immune as the FileEngine data safety appliance 22 initiates the communications with the Network Operation Center 132. Monitoring of hardware includes, for example, various collecting data from a motherboard temperature sensor 86, a CPU temperature sensor 88, a CPU fan RPM sensor 90, and a RPM sensor 92 associated with one of the two case cooling fans 72 and 74. Trend data is also stored and collected to diagnose or even predict failures.

If a condition arises that requires attention, the Vendor 102 will respond based on the condition. Some situations are easily corrected remotely by the Vendor 102 before the Customer 100 even knows of the situation. Other situations are easily corrected by the Customer 100. For example, inserting new removable backup media that was forgotten. Yet other situations require an onsite visit, but are not emergencies. For example, replacing a single failed hard drive 42 or 44. Some situations require as near to immediate response as can be provide. For example, a total failure of the data safety appliance 22. An illustrative embodiment of the Watchbot Monitoring System 174 is described in Section 7 of the attached Key Operator's Guide. All such features allow the provision of proactive attention to any problems with data safety appliance 22.

Remote Administration

For typical servers, local IT personnel must manage and deploy software updates, patches and the like. The illustrative system 40 includes technology tools that provide for Remote Administration 180 (FIG. 3) for the FileEngine data safety appliance 22, for example, as is further described in Section 8 of the attached Key Operator's Guide. Thus, the actual administration of all FileEngine data safety appliances 22 is located at the Network Operation Center 132 (FIG. 3) and utilizes an automated administration tool that is monitored by highly skilled network engineers. The user has no separate update patches, service packs, or other such admin issues to handle. All such upgrade or other service and monitoring tasks are handled via remote administration and are completely transparent to the user.

The Remote Administration 180 includes providing software deployment, thus reducing costs and increasing reliability and convenience. The Remote Administration 180 is generally transparent to the Customer 100. The Remote Administration 180, for example utilizing Remote Connection Server (“RCS”) 178, utilizes secure communications and is nearly firewall immune as the FileEngine data safety appliance 22 initiates periodic outbound communications that can be utilized for the resulting inbound Remote Administration 180.

For example, Remote Connection Server (“RCS”) 178 provides secure secure remote communication and administration of the FileEngine data safety appliance 22 from the Network Operation Center 132, even when the data safety appliance is located behind a firewall. This technique affords access to FileEngines that would otherwise be ‘hidden’ behind firewalls, routers or other hardware or software devices installed at the customers' premises. In one illustrative embodiment, the following process is used to implement the RCS 178.

A FileEngine data safety appliance 22 located on the customer's premises makes periodic requests over the Internet using HTTP protocol over port 80 to a Remote Connection Server (RCS) Host 182. It retrieves the status of a binary Communication Request Flag. A part of the request includes the FileEngine serial number so the flag will be retrieved for an individual FileEngine data safety appliance 22.

Under normal circumstances the Communication Request Flag is set to false which indicates that there are no pending requests for communication to the FileEngine data safety appliance 22.

When the Vendor 102 desires to communicate with the FileEngine data safety appliance 22 using a client PC 190, the state of the Communication Request Flag to set to true at RCS Host 182. In this implementation, a secure web page served by the RCS Host 182 uses a selectable feature of that web page to set the flag to true or false for that individual FileEngine data safety appliance 22.

When the FileEngine data safety appliance 22 receives the reply to the HTTP request and determines that the Communication Request Flag has been set to true, the RCS 178 application establishes an encrypted tunnel (using shared RSA keys) from the FileEngine data safety appliance 22 to a high port (the value of which was determined by and retrieved from the Remote Connection Server Host 182 along with the Communication Request Flag) of a VPN Server 186. The VPN Server 186 can be the same physical computer as that the RCS Host 182, or a different computer to enhance security. The ability to create an outbound connection is seldom restricted by local computer networks and/or their gateway/router devices or software configuration.

The Vendor 102 logs into the VPN Server 186 using Secure Shell Protocol (SSH) from the Client PC 190 using a shared RSA Key which is authenticated by looking up his credentials using a Lightweight Directory Access Protocol (LDAP) request to an Authentication Server 188 hosting the LDAP database. The LDAP service can be provided on another physical computer to enhance security, if desired. Using this technique, the Vendor 102 credentials may be administered at a single point (the Authentication Server 188) to allow removal of his rights to remotely communicate with FileEngine data safety appliance2 22 quickly, easily and absolutely.

Once credentials have been authenticated, console access is permitted to the VPN Server 186 whereupon the SSH configuration parameters are used to route encrypted terminal commands over the high port through the VPN tunnel to communicate with and administer the FileEngine data safety appliance 22.

When finished with the communication session, the terminal session on the FileEngine data safety appliance 22 is exited, the terminal session on the VPN Server 186 is exited, and the flag on the RCS Host 182 is set to zero.

An entry is made in the respective log files of the VPN Server 186 and RCS Host 182 indicating the login name, date, time and duration of the remote connection session.

Such remote administration can be used to allow Vendor 108, for example including Network Engineers (FileEngineers) and/or automated software, to perform diagnostics, repairs, configuration changes, updates, or any other needed remote administration.

Integrated Security

Some alternative systems such as NAS often utilize a webpage to access and change system administration parameters. The FileEngine data safety appliance 22 is more secure because it requires the FEAT 170 Win32 application to administer Users, Groups and File Storage Areas. Without a copy of FEAT 170 and the Administrator password, no changes can be made to security settings which are critical to the confidentiality of files.

The FileEngine data safety appliance 22 is configured on the local area network with a non-routable IP address, e.g. 192.168.X.X. There is no reason for the FileEngine data safety appliance 22 to receive inbound connections from the Internet 34; it is neither a Gateway nor Proxy server and does not terminate VPN connections.

The FileEngine data safety appliance 22 also incorporates a secure communications feature that provides the FileEngine data safety appliance 22 with the ability to administer the data safety appliance 22 remotely without the necessity of having ports forwarded to the FileEngine data safety appliance 22 from a LAN router. Remote communication with the FileEngine data safety appliance 22 is always encrypted and carefully controlled.

Illustrative embodiments of the FileEngine data safety appliance 22 that are Linux based also do not suffer from viruses and other security threats that other operating systems, for example Microsoft Windows, can be susceptible to, especially if not kept up-to-date with patches, updates and service packs.

The FileEngine data safety appliance 22 can operate as a Domain Controller that centralizes the security administration of the network PCs. For example, the data safety appliance can authenticate users' logins from workstations and enforce password policies, cause login scripts to be run automatically after login, and enforce permission-based access to files, even if the files are on a network Microsoft Windows based PC.

The FileEngine data safety appliance 22 lacks a keyboard, monitor or mouse in order to help provide protection from accidental and malicious access or damage to the shared data files and backups. Instead, the FileEngine data safety appliance 22 may include a user interface 55 on the case, for example, a four line LCD 54 and associated four pushbutton switch panel 56. The optional user interface 55 allows limited control functions for the FileEngine data safety appliance 22 are available, for example:

Making and Restoring Backups;

Rebuilding the data safety appliance, i.e., disaster recovery

Creating a Takeout media;

Shutting down or restarting the data safety appliance;

Performing diagnostics;

and as are further described in Section 6 of the attached Key Operator's Guide. In order to provide security, various functions require that a Key Operator 146 or Vendor PIN be entered to initiate the function.

Available diagnostics may include confirmation of the IP address and net mask assigned to the FileEngine data safety appliance 22, and a ping gateway function to confirm that the FileEngine networking sub-system is working, e.g., to verify that the network pre-configuration information was correct determined and/or selected among other diagnostics. Additionally, the FileEngine's IP address can be pinged from a network PC.

Integrated Data Protection

The system 40 can provide multiple and redundant forms of data protection, for example, various levels of RAID 42 and 44, DVD backup 48, tape backup 50, Self Serve Restore (“SSR”) 164, Deleted File Recovery Area (“DFRA”) 162, and offsite backup storage 134 (FIG. 3). Removable media 48 and 50 and offsite backup storage 134 that can provide disaster recovery restoration include data files; all user, group, and File Storage Areas configuration information; and system state information. Removable media drives 48 and 50 include those utilizing optical, magnetic, semiconductor, and emerging data storage technologies known in the art. For example, removable media drives 48 and 50 may include a cartridge drive, zip drive, removable hard drive, or other means. The data safety appliance 22 may include none, one, two, or more than two removable media drives 48 and 50. For example, offsite backup storage 134 can be utilized for a data safety appliance 22 have no removable media drives 48 and 50.

SSR 164 preserves nightly ‘snapshots’ of selected File Storage Areas, for example in a dedicated SSR partition on the RAID 42 and 44, for example, for up to two weeks. For example, SSR backup archive is accomplished using an archive to primary storage ratio of only 1.7 to 1. A server based Deleted File Recovery Area 162, for example, stored on the RAID 42 and 44, provides recovery of files deleted by a user.

Configuration information determines the data for backups on removable media such as DVDs. Upon completion of a backup, the backup DVD, tape, or other media is automatically ejected to indicate that the backup process was successful and to alert the user to store the created backup media in a safe location and to insert new backup media. Before the backup is completed, every backup is compared with the original data prior to ejecting the media; therefore, Customers 100 can have confidence in the visual cue of the ejected DVD tray or tape. The amount of data storage on typical removable media, for example 12 GB compressed for a DVD-DL, may require that specific FSAs be included or exclude from daily backup on removable media. FEAT provides selection of FSAs to include or exclude. The DVD media uses the standard UDF format and may be used in, and the data copied onto, a standard Windows PC equipped with a compatible DVD drive using the FileEngine Archive Recovery Tool 184.

A dedicated Takeout partition simplifies moving data to CD, DVD or DVD-DL removable media. The integrated off-site storage area 134 can provide additional or alternative protection by sending data to a remote/secure data center nightly. For example, the offsite backup can be configured to include any number of archives, for example, data stored last night and the two previous Friday nights, or 13 accounting periods.

The UPS 46 provides temporary power and can incorporate a serial communication system that provides an alert to the FileEngine data safety appliance 22 when AC power is interrupted, thus insuring a safe, controlled interruption of data services before power is lost.

Integrated File and Disaster Recovery

Disaster Recovery or recovery of selected files is available from the various backup data forms created by the above described data protection methods and hardware. For prior art file servers, the time required for a technician to restore a server after a disaster, e.g. total loss of a network server or associated storage device, is typically 20-25 hours and requires special skill, preparation, and software. Such prior disaster recovery is very expensive and a Customer 100 can be critically harmed by the lack of a server being available days or even a week.

Disaster recovery using the illustrative system 40 can typically be completed in 30 minutes to two hours without the intervention of skilled IT staff. In the event the FileEngine data safety appliance experiences a disaster requiring full recovery, the system 40 includes a special Disaster Recovery features that replace the typical 20 or more hours of skilled IT staff work with a few hours of work, for example, by a Key Operator or other minimally skilled individual.

For example, the FileEngine data safety appliance 22 utilizes standardized hardware and daily backups to easily and quickly recover not just the data but also all the information required to rebuild the data safety appliance in the event of a total system failure. In the even of a hardware failure requiring replacement, if a compatibly equipped FileEngine data safety appliance 22 is not available locally, for example, from an IT Partner, the Vendor 102 simply overnight ships a replacement FileEngine data safety appliance 22 to the Customer 100. The user simply slips in the backup DVD or other media, selects restore via the LCD and pushbutton panel 54 and 56, and the data safety appliance 22 is automatically restored to its previous configuration and with the restored data files and is ready for use in a matter of few hours. Alternatively, the FileEngine data safety appliance 22 is prepared with the prior night's backup maintained at Vendor's offsite storage facility 134 and delivered with the customer's data, users, groups and the like already installed.

If the hardware is intact, the disaster recovery is provided by simply loading the backup media (DVD or tape), pressing the Disaster Recovery pushbutton 56, and entering a PIN, again restoring the data safety appliance 22 automatically to its previous configuration and with the restored data files in a matter of a few hours.

In the event an individual file or folder is accidentally deleted by a user, the FileEngine data safety appliance 22 includes a Deleted File Recovery Area (“DFRA”) 162, so that files deleted from the server can be recovered easily, similar to the ‘Recycle Bin’ method available on individual PCs. For example, the DFRA comprises a dedicated partition on the RAID 42 and 44.

The FileEngine data safety appliance 22 also includes Self-Serve Restore of particular files or folders. Self Serve Restore can be completed on a PC 28 from a dedicated SSR partition on the RAID 42 and 44 containing backups, for example, selected data files can typically be included in up to 14 days of nightly snapshots. Offsite data storage 134 also provides file recovery.

This feature allows the end-user to easily recover from limited disasters such as the accidental deletion or overwriting of a particular file or folder. For example, the FileEngine data safety appliance can provide convenient restoration by the end-user of data that was snapshot archived during any day of the previous two weeks. The end-user simply uses a GUI interface to select the file(s) or folder(s) to be restored from the archive to the active shared file access space, all without requiring locating and inserting the backup media (e.g. DVDs) for a particular day and without the assistance of a skilled technician. For example to restore files from the Self Serve Restore snapshots, simply use a PC 28 to browse to the Self Serve Restore area and locate the desired data folder which identifies the date and day of the week the snapshot was created. Files stored in the SSR area are marked Read Only so they may not be changed. The user would then select the file or directory, and drag and drop it to the desired live file folder.

For restore of limited files from backup media (DVD or tape), the Restore function is access by loading the backup media, pressing the Restore pushbutton 56, and entering a PIN. The Restore function returns all the data from that backup to the dedicated Restore partition which is marked Read Only so files restored thereto may not be changed. The dedicated Restore partition is sized to accommodate the entire backup dataset size, thus eliminating the risk of over-writing live data during backup recovery. From there it is a simple matter for the recovered data to be located on the Restore partition, for example, using Windows Explorer on a network PC 28, and selecting, dragging, and dropping the desired files to the proper location in the live file system. This approach protects against the potential calamity of restoring too much data to the wrong place.

Additionally, daily DVD backups can be used to restore files directly to a PC having a DVD drive as is typically now available on most PCs. The system 40 can include a FileEngine Archive Recovery Tool (“FEAR”) 184. This application enables a Microsoft Windows PCs to efficiently handle archive files on the DVD which may exceed 8 GB, thus enabling the backup media to be used directly on PCs. This portability allows for emergency recovery in the event of a true disaster. In addition, backup media may be encrypted to prevent unauthorized use.

Built-in security features require that some or all of these restore functions to be performed by members of the designated Backup Operators Group. Typical media based backup devices use magnetic tape cassettes; however, DVDs provide various advantages over tape backups, one of which is cost. Typical tape media costs $30 each while typical DVD media costs $0.30 each. Additionally, unlike tapes, DVD media can be utilized on most PCs, including laptops. Thus, backups are easily accessible from most PCs, not just the specialized hardware on which they were created.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

1. A data safety appliance system for file serving and backup on a local area network, comprising:
(a) a data safety appliance, including:
a processor;
a fault tolerant and redundant data storage subsystem;
a WAN interface for communication with a wide area network;
a remote connection server adapted to initiate communications over the wide area network and to facilitate remote administration of the data safety appliance;
an operating system and supporting applications adapted for serving of files stored on the data storage subsystem, including:
file storage areas for defining where shared files are stored and backup options associated with the file; and
groups for defining permissions for access to file storage areas;
file server parameters;
local area network parameters; and
a local monitoring application adapted to determine performance data relating to the performance of the data safety appliance and to transmit that data over the wide area network; and
a LAN interface for communication with the local area network;
(b) a service infrastructure, including:
a remotely located network operation center;
a remote monitoring application adapted to receive the performance data from the data safety appliance and to correlate, analyze, and generate alarm signals based on the performance data and preset performance parameters.
a remote connection server host adapted to communicate over the wide are network with the remote connection server;
remote backup of at least a portion of the files and the file storage area, group, file server, and local area network parameters; and
a remote administration application adapted to notify the data appliance server of required remote administration via the remote connection server host and remote connection server.

2. A system for acquiring and employing a data safety appliance for file serving and backup on a customer network, comprising:
a customer access processor;
a financial partner processor; and
a vendor processor adapted by software to:
receive a request for a data safety appliance from a customer access processor;
receive approval of request from the financial partner processor;
receive pre-configuration information for the data safety appliance from at least one of the customer access processor and the customer network;
receive a service agreement from the customer;
quality analysis and correction of the pre-configuration information;
configuration of the data safety appliance based on the pre-configuration information;
deployment of the data safety appliance in the customer network; and
remote monitoring, administration, and backup of the data safety appliance subsequent to deployment on the customer network.
